(19) United States
(12) Patent Application Publication
(10) Pub. No.: US 2021/0010684 A1
(43) Pub. Date: Jan. 14, 2021

(54) INFRARED WARMER DEVICE AND METHOD FOR CONTROLLING THE SAME

(71) Applicants: Hyundai Motor Company, Seoul (KR); Kia Motors Corporation, Seoul (KR); Unick Corporation, Gimhae-si (KR)

(72) Inventors: So La CHUNG, Seoul (KR); Man Ju OH, Yongin-si (KR); Jae Woong KIM, Hwaseong-si (KR); Sang Shin LEE, Suwon-si (KR); Im Kwan PARK, Gimhae-si (KR); Dong Seok KIM, Changwon-si (KR)

(73) Assignees: Hyundai Motor Company, Seoul (KR); Kia Motors Corporation, Seoul (KR); Unick Corporation, Gimhae-si (KR)

(21) Appl. No.: 16/816,678

(22) Filed: Mar. 12, 2020

(30) Foreign Application Priority Data
Jul. 10, 2019 (KR) 10-2019-0083303

(51) Int. Cl. F24D 19/10; H05B 3/14; B60H 1/22

(52) U.S. Cl. CPC F24D 19/1096; F24D 2200/08; B60H 1/2226; H05B 3/145

(57) ABSTRACT

An infrared warmer device may include a touch sensor unit including a detecting wire mounted adjacent to a heating layer; a temperature sensor unit mounted adjacent to the heating layer; a cover covering the heating layer, an electrode unit, the touch sensor unit, and a temperature sensor unit; and a control unit controlling an amount of electric power supplied through the electrode unit such that a temperature detected by the temperature sensor unit reaches a target temperature, and changing the target temperature to a safe temperature when a touch of a body is detected through the touch sensor unit.

### CROSS REFERENCE TO RELATED APPLICATION

The present application claims priority to Korean Patent Application No. 10-2019-0083303, filed Jul. 10, 2019, the entire contents of which is incorporated herein for all purposes by this reference.

### BACKGROUND OF THE INVENTION

### Field of the Invention

The present invention relates to an infrared warmer device capable of achieving warmth through carbon fibers or the like, automatically controlling a temperature to meet a user's intention, and preventing a user from being burned by restricting electric power supply when the infrared warmer device is touched by the user, and a method for controlling the same.

### Description of Related Art

The technologies capable of heating through an air conditioning device, and heating a seat, a steering wheel, or the like using a heating wire has been currently applied to a vehicle.

However, in the very cold winter, when air heated through a heating device is discharged to the interior of the vehicle, hot air moves upwardly inside the vehicle due to the difference in air density, and as a result, passenger's eyes and skin get dried. Therefore, passengers tend to restrain themselves from using a heater even in the winter, and moderately endure coldness in a car.

Accordingly, besides air-based convection heating, the technology for heating the seat and the steering wheel has been employed as a concept of contact-type heating, but this also has a limit in solving a phenomenon that thighs and the like are cold due to the inflow of cold air through a gap in a door.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an infrared warmer device configured for achieving warmth through carbon fibers or the like, automatically controlling a temperature to meet a user's intention, and preventing a user from being burned by restricting electric power supply when the infrared warmer device is touched by the user, and a method for controlling the same.

According to an exemplary embodiment of the present invention, an infrared warmer device includes: a heating layer including a plurality of heating wires spaced from one another; an electrode unit connected to the heating layer to supply electric power to the heating wires; a touch sensor unit including a detecting wire disposed adjacent to the heating layer; a temperature sensor unit mounted adjacent to the heating layer; a cover covering the heating layer, the electrode unit, the touch sensor unit, and the temperature sensor unit; and a control unit controlling an amount of electric power supplied through the electrode unit such that a temperature detected by the temperature sensor unit reaches a target temperature, and changing the target temperature to a safe temperature when a touch of a body is detected through the touch sensor unit.

The infrared warmer device may further include a base mounted therein, and the heating layer, the electrode unit, the touch sensor unit, and the temperature sensor unit may be mounted between the base and the cover.

The heating wires of the heating layer may be carbon fibers.

The detecting wire may be mounted between the heating wires.

The heating wires and the detecting wire may be configured as a plurality of lines extending in a transverse direction of the cover, and the number of the detecting wire lines may be smaller than that of the heating wire lines, each of the detecting wire lines being mounted between the corresponding heating wire lines while being spaced therefrom at a predetermined interval.

Each of the heating wires may extend in a transverse direction of the cover and may be bent consecutively in a zig-zag shape, and the temperature sensor unit may be mounted adjacent to a bent portion of one of the heating wires.

Each of the heating wires may extend in a transverse direction of the cover and may be bent consecutively in a zig-zag shape, and the detecting wire may extend between the heating wires in a zig-zag shape in the same way as the heating wires while not directly contacting with the heating wires.

The control unit may receive an external temperature outside the infrared warmer device through a separate sensor, and provide the electric power to the heating wires through the electrode unit when the external temperature is equal to or lower than a reference temperature.

When the external temperature is equal to or lower than the reference temperature, the control unit may set the target temperature differently depending on the external temperature.

The control unit may set the target temperature to be higher as the external temperature is lower.

The control unit may have a maximum target temperature, and the reference temperature may be lower than the maximum target temperature.

The safe temperature may be higher than the reference temperature.

The safe temperature may be lower than the reference temperature.

According to various exemplary embodiments of the present invention, a method for controlling the infrared warmer device as described above includes: obtaining a measurement temperature through the temperature sensor unit; supplying electric power to the heating layer through the electrode unit; controlling an amount of electric power supplied from the electrode unit such that the measurement temperature reaches the target temperature; detecting a contact of a body through the touch sensor unit; changing the target temperature to the safe temperature, when the contact of the body is detected; and controlling the amount of electric power supplied from the electrode unit such that the measurement temperature reaches the safe temperature.

When the contact of the body is not detected after the contact of the body is detected through the touch sensor unit, the method for controlling the infrared warmer device may further include controlling the amount of electric power supplied from the electrode unit so that the measurement temperature reaches the original target temperature back.

In the supplying of the electric power to the heating layer, when an external temperature outside the infrared warmer device is equal to or lower than a reference temperature, the electric power is supplied to the heating layer through the electrode unit. In the controlling of the amount of the electric power supplied from the electrode unit so that the measurement temperature reaches the target temperature, the target temperature is set to vary depending on the external temperature.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an exploded view of an infrared warmer device according to an exemplary embodiment of the present invention.

FIG. 2 is a view showing a heating layer and a touch sensor unit of an infrared warmer device according to an exemplary embodiment of the present invention.

FIG. 3 is a view showing a heating wire and a temperature sensor of an infrared warmer device according to an exemplary embodiment of the present invention.

FIG. 4 and FIG. 5 are graphs for explaining the control of an infrared warmer device according to an exemplary embodiment of the present invention.

FIG. 6 is a flowchart of a method for controlling an infrared warmer device according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

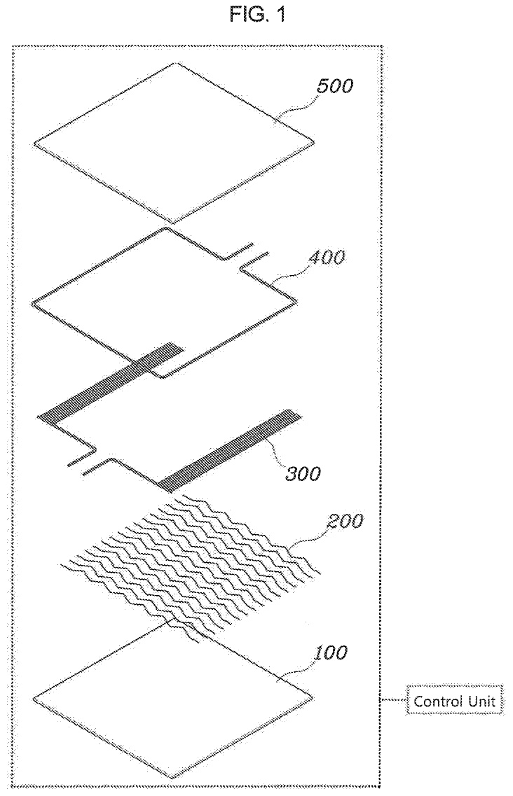

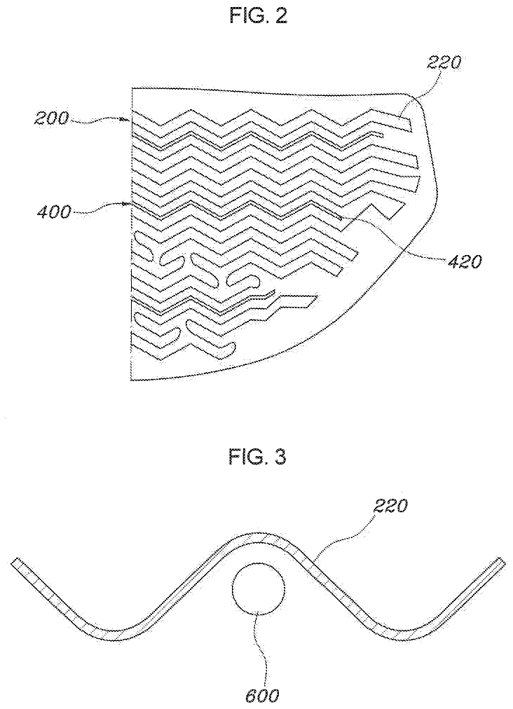

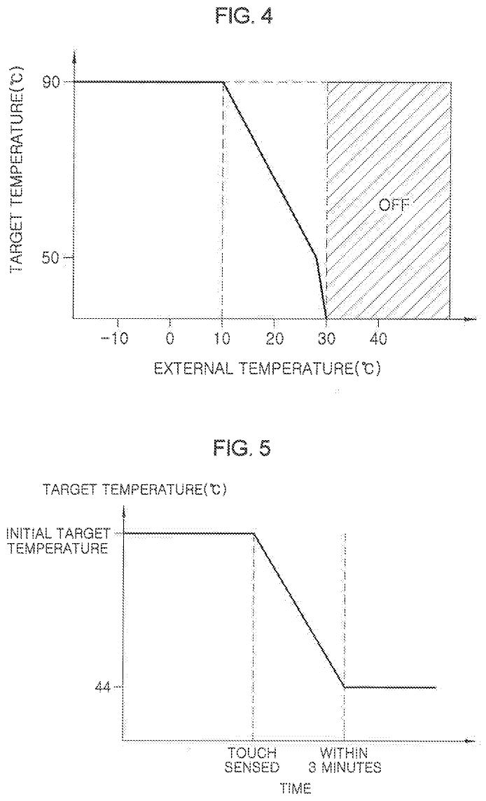

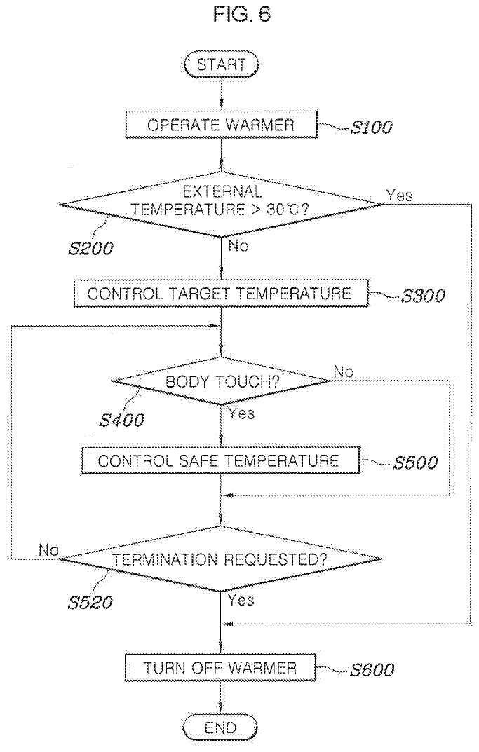

FIG. 1 is an exploded view of an infrared warmer device according to an exemplary embodiment of the present invention, FIG. 2 is a view showing a heating layer and a touch sensor unit of an infrared warmer device according to an exemplary embodiment of the present invention, FIG. 3 is a view showing a heating wire and a temperature sensor of an infrared warmer device according to an exemplary embodiment of the present invention, FIG. 4 and FIG. 5 are graphs for explaining the control of an infrared warmer device according to an exemplary embodiment of the present invention, and FIG. 6 is a flowchart of a method for controlling an infrared warmer device according to an exemplary embodiment of the present invention.

An infrared warmer device according to an exemplary embodiment of the present invention includes: a heating layer 200 including a plurality of heating wires spaced from one another; an electrode unit 300 connected to the heating layer 200 to supply electric power to the heating wires; a touch sensor unit 400 including a detecting wire mounted adjacent to the heating layer 200; a temperature sensor unit 600 mounted adjacent to the heating layer 200; a cover 500 covering the heating layer 200, the electrode unit 300, the touch sensor unit 400, and the temperature sensor unit 600; and a control unit controlling an amount of electric power supplied through the electrode unit 300 such that a temperature detected by the temperature sensor 600 reaches a target temperature, and changing the target temperature to a safe temperature when a touch of a body is detected through the touch sensor unit 400.

A control unit according to an exemplary embodiment of the present invention may be implemented through a nonvolatile memory configured to store data about algorithms configured to control operations of various components of a vehicle or software instructions for reproducing the algorithms, and a processor configured to perform the operations which will be described below using the data stored in the memory. Here, the memory and the processor may be implemented as independent chips. Alternatively, the memory and the processor may be implemented as an integrated single chip, and the processor may take on the form of one or more processors. Although not illustrated, the control unit is connected to the temperature sensor to receive a temperature value, is connected to the electrode unit to control an amount of electric power, and stores a target temperature value, a safe temperature value, and the like required for the control as a table or the like.

Meanwhile, the use of the present invention is not particularly limited, but the present invention is particularly effective when used on an internal material of a vehicle. Since cold wind flows into the interior of the vehicle through a door gap or the like, the infrared warmer device may be installed on various parts close to the body such as a door trim, a lower trim of a steering column, a console, or an armrest.

The present invention is capable of providing warmth to the body by transferring radiant heat using far infrared rays through carbon fibers from a region close to the body. Thus, it is advantageous to adopt the carbon fibers as heating wires.

A general metal wire is advantageous in heat transfer by conduction, and thus is not effective on an indoor trim spaced from the body as in an exemplary embodiment of the present invention.

The heating layer 200 in an exemplary embodiment of the present invention is mounted on a base 100. The heating layer 200 includes a plurality of heating wires spaced from one another. The heating wires are mounted on the entire surface of the base 100 to be spaced from one another by a certain distance so that the entire area may be evenly utilized.

As illustrated, the electrode unit 300 connects respective end portions of the plurality of heating wires, which extend in a transverse direction in parallel with each other, to supply electric power through a positive electrode and a negative electrode. Such electrodes may be provided to be woven together with the heating wires. Accordingly, each heating wire is heated by applying a current thereto and radiates radiant energy, when supplied with electric power from the electrode unit 300.

The touch sensor unit 400 is also provided on the base 100. The touch sensor unit 400 includes a detecting wire, and a sensor configured for detecting a change in capacitance caused by a contact of a body is suitable. Furthermore, the heating wires and the detecting wire are spaced from each other not to overlap each other so that the change in capacitance may be detected without noise, and wirings (connecting portions) of the electrode unit 300 and the touch sensor unit 400 are directed to different directions from each other, minimizing the noise.

The temperature sensor 600 is mounted adjacent to the heating layer 200 to directly measure thermal energy radiated from the heating layer 200, achieving fast measurement and responsiveness.

Finally, the cover 500 is mounted. The cover 500 covers the heating layer 200, the electrode unit 300, the touch sensor unit 400, and the temperature sensor 600, making it possible to protect internal portions. The cover 500 having portions embedded therein may be combined with the base 100, or integrated with the base 100 by an insert injection molding method or the like.

The control unit serves mainly to control the electrode unit 300. The control unit controls an amount of electric power supplied from the electrode unit 300 such that a temperature detected by the temperature sensor 600 reaches a target temperature. The control unit changes the target temperature to a safe temperature when a contact of a body is detected through the touch sensor unit 400 to prevent the body from being burned.

The heating wires of the heating layer 200 may be carbon fibers. In the instant case, radiant energy is used, and a heat capacity is low as compared to a resistance of metal. As a result, there is a low risk of a burn and it is possible to effectively provide warmth even though a trim is located apart from a body.

Furthermore, the detecting wire may be mounted between the heating wires. As illustrated in FIG. 2, the heating wires and the detecting wire are configured as a plurality of lines 220 and 420 extending in the transverse direction of the cover, and the number of the detecting wire lines 420 is smaller than that of the heating wire lines 220. Each of the detecting wire lines 420 may be mounted between the corresponding heating wire lines 220 while being spaced therefrom at a predetermined interval.

The detecting wire is mounted in each of the spaces divided into upper, middle, and lower portions, effectively detecting a touch of a body at any point on the entire area of the base.

As illustrated in FIG. 3, the heating wire extends in the transverse direction of the cover and is bent consecutively in a zig-zag shape, and the temperature sensor 600 may be mounted adjacent to a bent portion of the heating wire. Since the temperature sensor 600 is mounted to be closest to the heating wire to measure a temperature of the heating wire, it is possible to measure a temperature before warmth is transferred to a user, ensuring the quickness of measurement. The control based thereon makes the responsiveness of the control faster. Also, since the temperature sensor 600 is inserted into the bent portion of the heating wire, it is possible to maintain durability in terms of installation.

Furthermore, the heating wire extends in the transverse direction of the cover and is bent consecutively in a zig-zag shape, and the detecting wire extends between the heating wires in a zig-zag shape in the same way as the heating wires while not directly contacting with the heating wires. That is, as illustrated in FIG. 2, the detecting wire and the heating wires extend in parallel with each other in a state where they are spaced from each other, effectively using the area, and improving accuracy of detecting with respect to a touch at a point where the heating wire is mounted and as a result preventing a burn.

Furthermore, the control unit may receive an external temperature outside the infrared warmer device through a separate sensor, and provide electric power to the heating wires through the electrode unit 300 when the external temperature is equal to or lower than a reference temperature. That is, the control unit receives data about a temperature outside and adjacent to the warmer device through an external temperature sensor, i.e., a sensor for detecting an indoor temperature of the vehicle, as well as temperature data through the internal temperature sensor. The control unit may provide electric power to the heating wires through the electrode unit 300 when the external temperature is equal to or lower than the reference temperature (e.g., about 30° C.). That is, since the user feels coldness at an indoor temperature of 30° C. or lower, the warmer device is activated only in such circumstances, preventing the use of unnecessary electric power or the heating which is not intended by the user.

Furthermore, when the external temperature is equal to or lower than the reference temperature (30° C.), the control unit may set the target temperature differently depending on the external temperature. FIG. 4 and FIG. 5 are graphs for explaining the control of an infrared warmer device according to an exemplary embodiment of the present invention. As illustrated in FIG. 4, when the external temperature is equal to or lower than the reference temperature, the control unit may set the target temperature differently depending on the external temperature. The control unit may set the target temperature to be higher as the external temperature is lower.

When the external temperature (the indoor temperature of the vehicle) is very low, the target temperature starts at about 90° C., which is the maximum target temperature. Once the external temperature (the temperature inside the vehicle) rises to about 10° C. or higher, heat generation is controlled in a mild way. The target temperature is set to decrease gradually as the external temperature is higher, and ultimately, when the external temperature reaches 30° C., the control unit performs a control not to generate heat. Such control is for not providing excessive warmth so that the user does not feel discomfort. Thus, the control unit has a maximum target temperature (e.g., 90° C.), and the reference temperature (e.g., 30° C.) may be lower than the maximum target temperature.

Furthermore, when a value measured by a sensor for measuring an indoor temperature of the vehicle is used in connection with the external temperature, the safe temperature may be higher than the reference temperature. That is, as illustrated in FIG. 5, when a user's touch is detected, the control unit controls the target temperature to be changed to the safe temperature. In the instant case, the safe temperature is set as about 44° C. to prevent a burn even when the user's body is in contact with the warmer device. Therefore, it is preferable to set the safe temperature (e.g., 44° C.) to be higher than the reference temperature (e.g., 30° C.).

Meanwhile, a separate temperature sensor may be installed on the control unit of the warmer device according to an exemplary embodiment of the present invention and utilized to measure an external temperature. In the instant case, an external temperature value may be slightly affected by the temperature of the heating layer or the control unit, and the reference temperature needs to rise because it is basically somewhat affected by the heat therefrom. Accordingly, it is preferable to set the safe temperature (e.g., 44° C.) to be lower than the reference temperature (e.g., 50° C.),

FIG. 6 is a flowchart of a method for controlling an infrared warmer device according to an exemplary embodiment of the present invention. The method for controlling the infrared warmer device according to an exemplary embodiment of the present invention includes: obtaining a measurement temperature through the temperature sensor; supplying electric power to the heating layer through the electrode unit (S100); controlling an amount of electric power supplied from the electrode unit such that the measurement temperature reaches the target temperature (S200); detecting a contact of a body through the touch sensor unit (S400); changing the target temperature to the safe temperature, when the contact of the body is detected (S500); and controlling the amount of electric power supplied from the electrode unit such that the measurement temperature reaches the safe temperature (S500).

When the contact of the body is not detected after the contact of the body is detected through the touch sensor unit, the method may further include: controlling the amount of electric power supplied from the electrode unit so that the measurement temperature reaches the original target temperature back (S300); and turning off the warmer device when a user's demand or a temperature condition is satisfied (S520 and S600).

In the supplying of the electric power to the heating layer, when the external temperature outside the infrared warmer device is equal to or lower than a reference temperature, electric power is supplied to the heating layer through the electrode unit. In the controlling of the amount of the electric power supplied from the electrode unit so that the measurement temperature reaches the target temperature, the target temperature may be set to vary depending on the external temperature.

According to the infrared warmer device and the method for controlling the same of the present invention, it is possible to achieve warmth through carbon fibers or the like, automatically control a temperature to meet the user's intention, and prevent the user from being burned by restricting electric power supply when the infrared warmer device is touched by the user.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An infrared warmer device comprising:
a heating layer including a plurality of heating wires spaced from one another;
an electrode connected to the heating layer to supply electric power to the heating wires;
a touch sensor including a detecting wire mounted adjacent to the heating layer;
a temperature sensor mounted adjacent to the heating layer to detect a temperature of the heating layer;
a cover covering the heating layer, the electrode, the touch sensor, and the temperature sensor; and
a controller configured of controlling an amount of the electric power supplied through the electrode to the heating layer so that the temperature detected by the temperature sensor reaches a target temperature, and of changing the target temperature to a predetermined temperature upon determining that a contact to the touch sensor is detected through the touch sensor.

2. The infrared warmer device of claim 1, further including a base,
wherein the heating layer, the electrode, the touch sensor, and the temperature sensor are mounted between the base and the cover.

3. The infrared warmer device of claim 1, wherein the heating wires of the heating layer are carbon fibers.

4. The infrared warmer device of claim 1, wherein the detecting wire is mounted between the heating wires.

5. The infrared warmer device of claim 1, wherein the heating wires and the detecting wire are configured as a plurality of lines extending in a transverse direction of the cover, and a number of the detecting wire lines is lower than a number of the heating wire lines, each of the detecting wire lines being mounted between the corresponding heating wire lines while being spaced therefrom at a predetermined interval.

6. The infrared warmer device of claim 1, wherein each of the heating wires extends in a transverse direction of the cover and is bent consecutively in a zig-zag shape, and the temperature sensor is mounted adjacent to a bent portion of one of the heating wires.

7. The infrared warmer device of claim 1, wherein each of the heating wires extends in a transverse direction of the cover and is bent consecutively in a zig-zag shape, and the detecting wire extends between the heating wires in a zig-zag shape in a same way as the heating wires while not directly contacting with the heating wires.

8. The infrared warmer device of claim 1, wherein the controller is configured to receive an external temperature outside the infrared warmer device through a sensor, and to provide the electric power to the heating wires through the electrode upon determining that the external temperature is equal to or lower than a reference temperature.

9. The infrared warmer device of claim 8, wherein upon determining that the external temperature is equal to or lower than the reference temperature, the controller is configured to set the target temperature to another target temperature determined based on the external temperature.

10. The infrared warmer device of claim 9, wherein the controller is configured to increase the target temperature as the external temperature is decreased.

11. The infrared warmer device of claim 8, wherein the controller has a maximum target temperature, and the reference temperature is set to be lower than the maximum target temperature.

12. The infrared warmer device of claim 8, wherein the predetermined temperature is higher than the reference temperature.

13. The infrared warmer device of claim 8, wherein the predetermined temperature is lower than the reference temperature.

14. A method for controlling an infrared warmer device, the method comprising:
obtaining, by a controller, a value of a temperature of a heating layer detected via a temperature sensor;
supplying, by the controller, electric power to the heating layer through an electrode;
controlling, by the controller, an amount of the electric power supplied from the electrode so that the detected temperature reaches a target temperature;
determining, by the controller, a contact to a touch sensor;
changing the target temperature to a predetermined temperature, upon determining that the contact of the touch sensor is detected; and
controlling the amount of the electric power supplied from the electrode to the heating layer so that the detected temperature reaches a predetermined temperature.

15. The method for controlling the infrared warmer device of claim 14, wherein the infrared warmer device includes:
the heating layer including a plurality of heating wires spaced from one another;
the electrode connected to the heating layer to supply the electric power to the heating wires;
the touch sensor including a detecting wire mounted adjacent to the heating layer;
the temperature sensor mounted adjacent to the heating layer;
a cover covering the heating layer, the electrode, the touch sensor, and the temperature sensor; and
the controller configured of controlling the amount of the electric power supplied through the electrode such that the detected temperature reaches a target temperature, and of changing the target temperature to a predetermined temperature upon determining that the contact to the touch sensor is detected through the touch sensor.

16. The method for controlling the infrared warmer device of claim 14, further including, upon determining that the contact to the touch sensor is not detected after the contact to the touch sensor is detected through the touch sensor, controlling the amount of the electric power supplied from the electrode so that the detected temperature reaches the target temperature back.

17. The method for controlling the infrared warmer device of claim 14, wherein in the supplying of the electric power to the heating layer, upon determining that an external temperature outside the infrared warmer device is equal to or lower than a reference temperature, the electric power is supplied to the heating layer through the electrode, and
in the controlling of the amount of the electric power supplied from the electrode so that the detected temperature reaches the target temperature, the target temperature is set to vary depending on the external temperature.
